(19) United States
(12) Patent Application Publication
(10) Pub. No.: US 2016/0307208 A1
(43) Pub. Date: Oct. 20, 2016

(54) Method and System to Enhance Social Engagement Accuracy by Developing a Virtual Hierarchy of Target Organization

(71) Applicant: Dell Software, Inc., Round Rock, TX (US)

(72) Inventors: Shree A. Dandekar, Cedar Park, TX (US); Mark W. Davis, Tracy, CA (US)

(73) Assignee: DELL SOFTWARE, INC., Round Rock, TX (US)

(21) Appl. No.: 14/688,511

(22) Filed: Apr. 16, 2015

(51) Int. Cl. G06Q 30/02; G06Q 50/00; H04L 29/08

(52) U.S. Cl. CPC G06Q 30/0201; H04L 67/22; G06Q 50/01

(57) ABSTRACT

A system, method, and computer-readable medium for performing a virtual organization operation for generating a virtual organization hierarchy that is based upon influence within an organization. More specifically, in certain embodiments, the operation generates a virtual organizational hierarchy that contains individuals, roles, contact information, responsibilities, estimates of purchasing authority, and other influential values. In certain embodiments, the virtual organization operation includes templates for virtual organizations of differing types to provide the capacity for handling differences in organizational structures like not-for-profits or educational establishments. Additionally, in certain embodiments, the virtual organization operation maintains semantic relationships between roles and individuals, thus enabling the virtual hierarchy to be used to identify missing decision makers and influencers in an organization as a whole, including the ability to infer the role of an individual within the hierarchy without knowing a specific title for the individual.

### BACKGROUND OF THE INVENTION

1. Field of the Invention

The present invention relates to information handling systems. More specifically, embodiments of the invention relate to developing a virtual hierarchy of a target organization.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Lead generation is the process of creating sales leads which might convert into a sale for a company. The leads may come from various sources or activities, for example, digitally via the Internet, through calls, emails, advertising, events, and list purchases. Traditionally companies also relied on referrals, telemarketers, and advertisements to generate leads. With the advent of social media it has become important for modern marketers and sales engineers to tap into the various social media channels (e.g., Facebook, Twitter, LinkedIn) to generate new and meaningful leads.

However, there can be issues related to making use of social media to generate leads. For example, often social profiles are not linked or can be rather challenging to intuitively link. For example, Bob Taylor on LinkedIn can have a totally different profile on Twitter ex: @maverick. Also, identifying the purchasing power and decision making potential via social media can be challenging. For example, even though Bob Taylor is titled as “Director of IT” on LinkedIn or a community website there is no way to know whether be is actually influential enough to make a buying decision for a product. To further complicate the matter of using social media to generate meaningful leads, individuals may have more than one account on the same social media channel. For example, Bob Taylor can have two twitter handles. One for this fantasy football chat @maverick gaming aficionado and the other for regular business interactions @Btaylor.

Accordingly, it would be desirable to provide a sales person with information regarding an exact persona of a be target lead along with the hierarchy of the person in an organization. Such a function would increase the efficiency of making a sale and increase the likelihood of connecting with the right person in an organization.

### SUMMARY OF THE INVENTION

A system, method, and computer-readable medium are disclosed for performing a virtual organization operation for generating a virtual organization hierarchy that is based upon influence within an organization. More specifically, in certain embodiments, the operation generates a virtual organizational hierarchy that contains individuals, roles, contact information, responsibilities, estimates of purchasing authority, and other influential values. In certain embodiments, the virtual organization operation includes templates for virtual organizations of differing types to provide the capacity for handling differences in organizational structures like not-for-profits or educational establishments. Also, in certain embodiments, the virtual organization hierarchies are enhanced with information as it becomes available from direct engagements and social media profiles. Additionally, in certain embodiments, the virtual organization operation maintains semantic relationships between roles and individuals, thus enabling the virtual hierarchy to be used to identify missing decision makers and influencers in an organization as a whole, including the ability to infer the role of an individual within the hierarchy without knowing a specific title for the individual.

More specifically, in one embodiment, the invention relates to a computer-implementable method for generating a virtual organization hierarchy, comprising: identifying a plurality of target individuals within an organization; monitoring a plurality of social media data and interactions of the target individuals with the plurality of social media data; and, generating the virtual organization hierarchy for the target individuals within the organization based upon influence of the plurality of individuals within the organization.

In another embodiment, the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: identifying a plurality of target individuals within an organization; monitoring a plurality of social media data and interactions of the target individuals with the plurality of social media data; and, generating the virtual organization hierarchy for the target individuals within the organization based upon influence of the plurality of individuals within the organization.

In another embodiment, the invention relates to A non-transitory, computer-readable storage medium embodying computer program code, the computer program code comprising computer executable instructions configured for: identifying a plurality of target individuals within an organization; monitoring a plurality of social media data and interactions of the target individuals with the plurality of social media data; and, generating the virtual organization hierarchy for the target individuals within the organization based upon influence of the plurality of individuals within the organization.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of a virtual organization hierarchy environment.

FIG. 3 shows a flow chart of an operation of a virtual organization system.

FIG. 4 shows a block diagram of an example organization chart.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

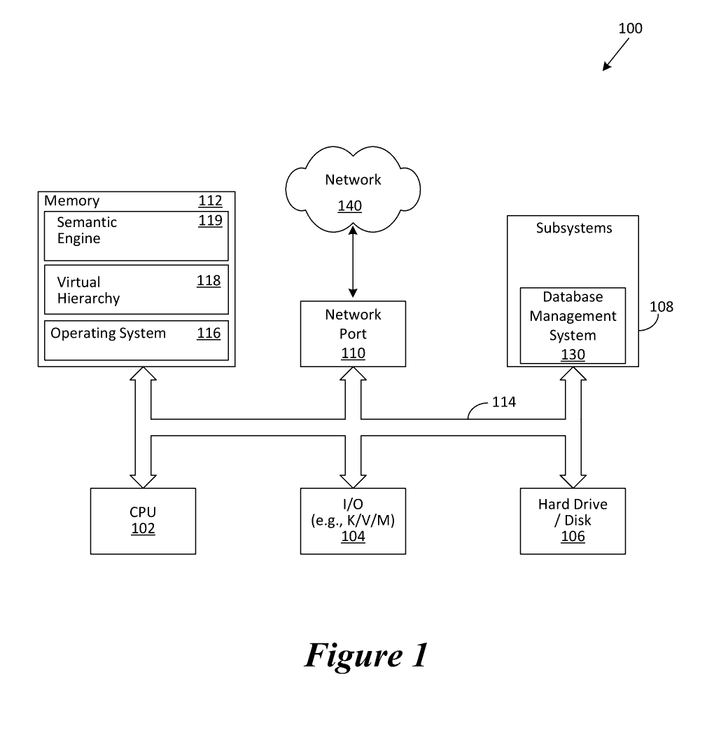

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a virtual hierarchy module 118 which includes an associated semantic engine 119.

The virtual hierarch module 118 performs a virtual organization operation for generating a virtual organization hierarchy that is based upon influence within an organization. More specifically, in certain embodiments, the virtual organization operation generates a virtual organizational hierarchy that contains individuals, roles, contact information, responsibilities, estimates of purchasing authority, and other influential values. In certain embodiments, the virtual organization operation includes templates for virtual organizations of differing types to provide the capacity for handling differences in organizational structures like not-for-profits or educational establishments. Also, in certain embodiments, the virtual organization hierarchies are enhanced with information as it becomes available from direct engagements and social media profiles. Additionally, in certain embodiments, the virtual organization operation maintains semantic relationships between roles and individuals, thus enabling the virtual hierarchy to be used to identify missing decision makers and influencers in an organization as a whole, including the ability to infer the role of an individual within the hierarchy without knowing a specific title for the individual. In certain embodiments, these semantic relationships are identified and maintained via the semantic engine 119. The semantic engine 119 uses location, intent, variation of words, synonyms, generalized and specialized queries, concept matching and natural language queries to provide relevant context to the organization hierarchy as well as individual roles. In addition to the context attribution, the semantic engine is also responsible to update information in real-time using machine learning.

The semantic relationships between members in the hierarchy further reinforce the ability to process and identify leads depending on the marketing and sales requirements. For example, an email marketing campaign can be targeted at Chief Information Officers or equivalents, allowing for variations in titles and roles by domains and organizational structure.

Further, the descriptive content of the virtual hierarchy can be used to associate individuals with multiple social media identities. For example, a fantasy football mention in a tweet can tie two Twitter accounts together to allow for better lead identification and interest matching. By using key words and phrases in context and ranking them against a model for different roles, ambiguous identities can be resolved with the attachment of a likelihood or probability of success. In certain embodiments, to achieve this a simple weighted index approach is used where the likelihood of a match is determined by assigning a. certain weight (e.g., a score) based on the context relevancy.

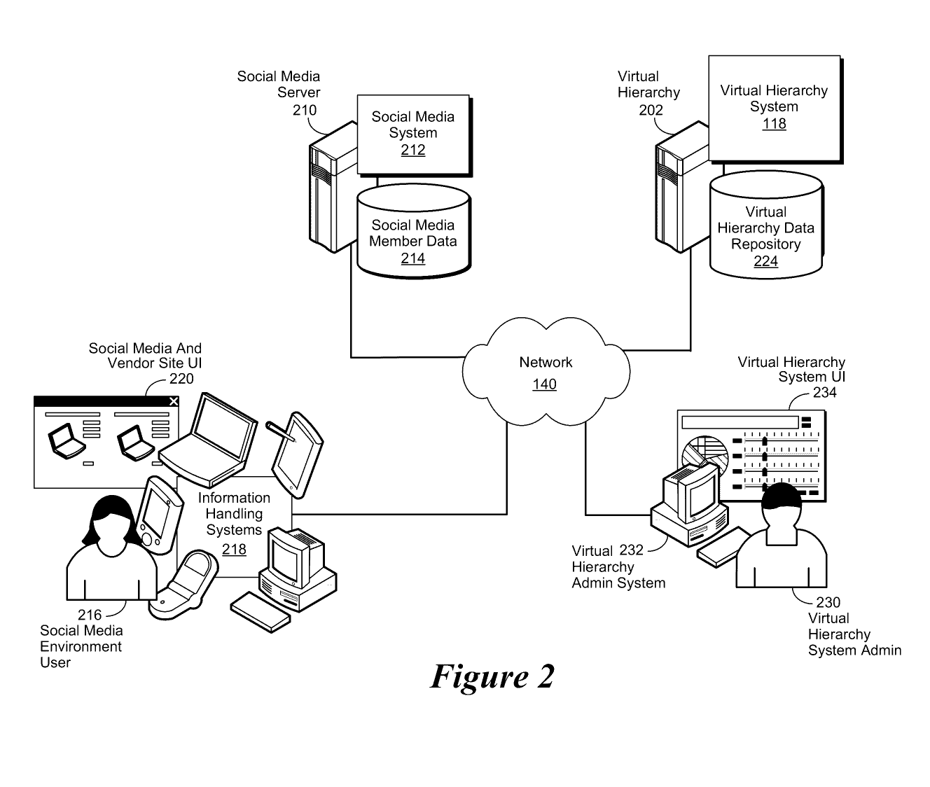

FIG. 2 shows a block diagram of a virtual organization hierarchy environment 200. In various embodiments of the invention, a virtual hierarchy system 118 is implemented to monitor user interactions and generate a virtual hierarchy based upon the user interactions, In these and other embodiments, a social media environment user 216 uses an information handling system 218 to log on to a social media environment, or site, enabled by a social media system 212, which is implemented on a social media server 210. As used herein, an information handling system 218 may comprise a personal computer, a laptop computer, or a tablet computer operable to exchange data between the social media environment user 216 and the social media server 210 over a connection to network 140. The information handling system 218 may also comprise a personal digital assistant (PDA), a mobile telephone, or any other suitable device operable to display a social media and vendor site user interface (UI) 220 and likewise operable to establish a connection with network 140.

In this embodiment, virtual hierarchy operations are performed by the virtual hierarchy system 118 to generate a virtual hierarchy based upon user social media interactions. In one embodiment, the social media interactions are monitored and collected by a social media crawler operable to perform crawling operations in a target social media environment. The collected social media interactions are then stored in the virtual hierarchy data repository 224. The source(s) (e.g., social media environment user 216) of the most relevant social media interactions are identified and they are then displayed in a virtual hierarchy system user interface (UI) 234 implemented on a virtual hierarchy administrator system 232. Once displayed, the sources are reviewed by an virtual hierarchy system administrator 230 to determine whether the relevant social media interactions cause a social media environment user to be added to or identified as an influencer within the virtual hierarchy.

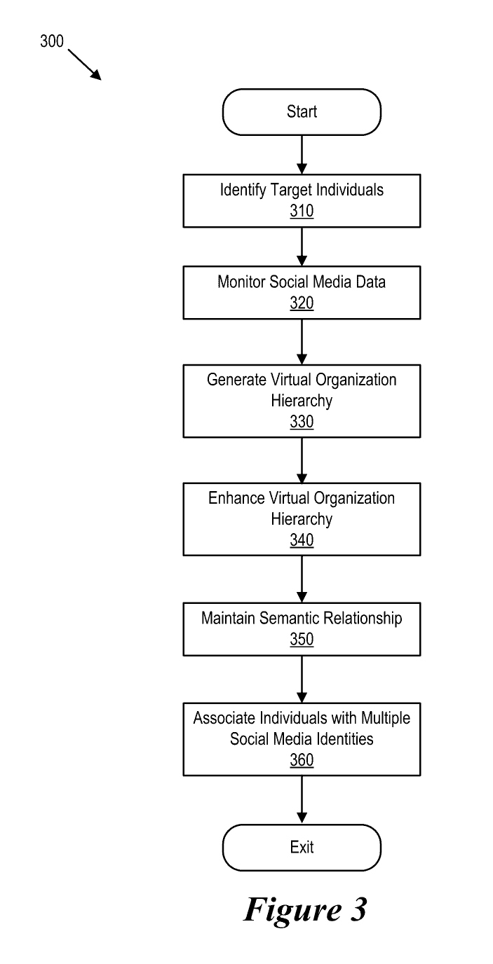

FIG. 3 shows a flow chart of the operation of a virtual hierarchy system 118. More specifically, the virtual hierarchy system 118 begins operation at step 310 by identifying target individuals or organizations for which a virtual hierarchy is desired. Next, at step 320, the virtual hierarchy system 118 monitors various social media data and interactions of the target individuals and/or organizations. Next, at step 330, the virtual hierarchy system 118 generates a virtual organization hierarchy for the target individuals within a target organization. The virtual organization hierarchy is based upon influence of the target individuals within the target organization. More specifically, in certain embodiments, the virtual organizational hierarchy contains individuals, roles, contact information, responsibilities, estimates of purchasing authority, and other influential values.

In certain embodiments, when generating the virtual organization hierarchy, virtual hierarchy system 118 identifies a type of organization for which the virtual organization hierarchy is being generated. After identifying a type of organization, the virtual hierarchy system 118 accesses templates for virtual organizations of differing types to provide the capacity for handling differences in organizational structures like not-for-profits or educational establishments.

Next, at step 340, the virtual organization hierarchy is enhanced with information as it becomes available from direct engagements and social media profiles. Next, at step 350, the virtual hierarchy system 118 maintains semantic relationships between roles and individuals, thus enabling the virtual hierarchy to be used to identify missing decision makers and influencers in an organization as a whole, including the ability to infer the role of an individual within the hierarchy without knowing a specific title for the individual.

Next, at step 360, the descriptive content of the virtual hierarchy is used to associate individuals with multiple social media identities. By using key words and phrases in context and ranking them against a model for different roles, ambiguous identities of individuals within the virtual hierarchy can be resolved with the attachment of a likelihood or probability of success.

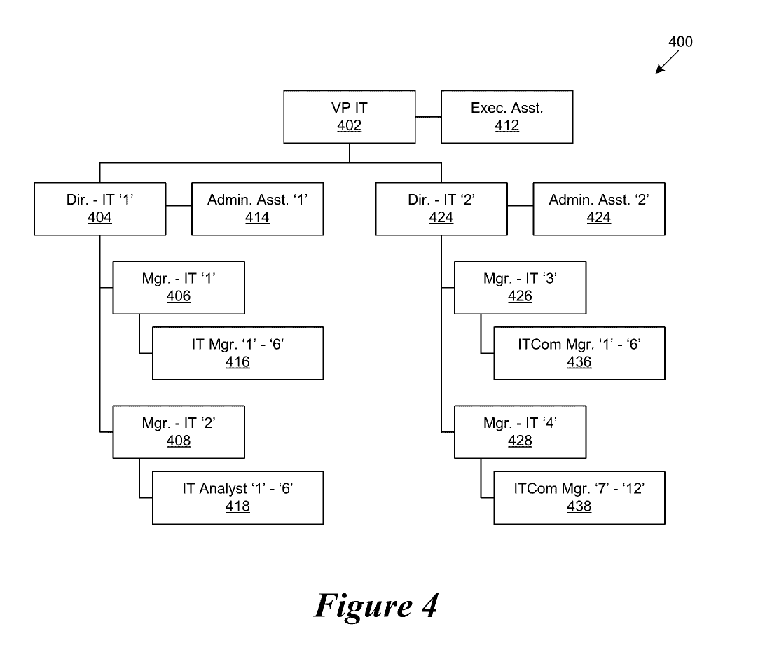

Referring to FIG. 4, a block diagram of an example simplified organization chart generated by a virtual hierarchy organization system is shown. In this example, the organization chart 400 depicts the structure of an information technology (IT) organization that is headed by a Vice President (VP) of IT 402, who has direct reports that include an Executive Assistant 412 and Directors of IT ‘1’ 404 and ‘2’ 424.

Likewise, the Director of IT ‘1’ 404 has direct reports that include an Administrative Assistant ‘1’ 414 and Managers of IT ‘1’ 406 and ‘2’ 408. In turn, the Managers of IT ‘1’ 406 and ‘2’ 408 respectively have six direct reports each that include IT Managers ‘2’ through ‘6’ 416, and IT Analysts ‘1’ through ‘6’ 418. The Director of IT ‘2’ 424 likewise has direct reports that include an Administrative Assistant ‘2’ 434 and Managers of IT ‘3’ 426 and ‘4’ 428. In turn, the Managers of IT ‘3’ 426 and ‘4’ 428 respectively have six direct reports each that include IT Communication (ITCom) Managers ‘1’ through ‘6’ 436, and IT Analysts ‘1’ through ‘6’ 438.

In various embodiments, organization structure data associated with the organization chart 400 is generated and managed via the virtual organization system 118. As used herein, organization structured data broadly refers to data associated with an organization structure, such as the organization chart shown in FIG. 4. Additionally, a virtual organization structure represents an organizational structure as it actually functions as compared to a structure as it may be defined internally by the organization. As such, it can be used to define how activities such as influence over purchasing decisions, task allocation, coordination and supervision are actually performed by the organization. For example, in certain organizations, a first director (e.g., Dir.—IT ‘1’) may have influence over purchasing decisions whereas another director may not (e.g., Dir.—IT ‘2’). It, can also provide information regarding gatekeepers to those individuals that have influence over purchasing decisions. For example, in certain organizations, first director (e.g., Dir.—IT ‘1’) has influence over purchasing decisions then the administrative assistant to this director may be a gatekeeper to accessing the appropriate person. In addition, it can provide a perspective of how individuals perceive their organization and its environment.

Those of skill in the art will realize that an organization may be structured in many different ways, depending on their objectives. Further, the structure of an organization often determines the modes in which it operates and performs. It will likewise be appreciated that various organizational structures allow the expressed allocation of responsibilities for different functions and processes to different entities such as a branch, a department, a workgroup, or an individual, In various embodiments, organization structure data includes influencer data as well as other information associated with an individual's role.

As will be appreciated by one skilled in the art, the present invention may be embodied as a method, system, or computer program product. Accordingly, embodiments of the invention may be implemented entirety in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchartillustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for generating a virtual organization hierarchy, comprising:
identifying a plurality of target individuals within an organization;
monitoring a plurality of social media data and interactions of the target individuals with the plurality of social media data; and,
generating the virtual organization hierarchy for the target individuals within the organization based upon influence of the plurality of individuals within the organization.

2. The method of claim 1, wherein:
the virtual organizational hierarchy comprises information regarding at least some of individuals, roles, contact information, responsibilities, estimates of purchasing authority, and other influential values.

3. The method of claim 1, wherein:
the generating further comprises identifying a type of organization and accessing a templates for organizations corresponding to the type of organization.

4. The method of claim 1, further comprising:
enhancing the virtual organization hierarchy as additional information becomes available from direct engagements and social media profiles.

5. The method of claim 1, wherein:
the generating comprises maintaining semantic relationships between roles and individuals, the semantic relationships enabling the virtual hierarchy to be used to identify missing decision makers and influencers in the organization, including an ability to infer a role of an individual within the hierarchy without knowing a specific title for the individual, maintaining semantic relationships comprising associating identities to roles in the virtual organization hierarchy based on words and phrases present in social media data of the individual; and,
the generating further comprising inferring roles and identities of individuals within the virtual organization hierarchy by identifying unused roles in the virtual organization hierarchy and combining a probability of assignment to those roles with the associating identities or roles.

6. The method of claim 1, wherein:
the virtual organization hierarchy represents a plurality of roles within the organization, a hierarchy of roles within the organization, relationships between roles within the organization, and a plurality of keys, values, and weight indicators related to the roles and relationships;
the generating further comprises assigning social media identities, email addresses, business card information, and factual indicators to the plurality of individuals within the virtual hierarchy; and,
assigning respective metric values to the factual indicators, the metric values representing a veracity of respective factual indicators.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
identifying a plurality of target individuals within an organization;
monitoring a plurality of social media data and interactions of the target individuals with the plurality of social media data; and,
generating the virtual organization hierarchy for the target individuals within the organization based upon influence of the plurality of individuals within the organization.

8. The system of claim 7, wherein:
the virtual organizational hierarchy comprises information regarding at least some of individuals, roles, contact information, responsibilities, estimates of purchasing authority, and other influential values.

9. The system of claim 7, wherein:
the generating further comprises identifying a type of organization and accessing a templates for organizations corresponding to the type of organization.

10. The system of claim 7, wherein:
enhancing the virtual organization hierarchy as additional information becomes available from direct engagements and social media profiles.

11. The system of claim 7, wherein:
the generating comprises maintaining semantic relationships between roles and individuals, the semantic relationships enabling the virtual hierarchy to be used to identify missing decision makers and influencers in the organization, including an ability to infer a role of an individual within the hierarchy without knowing a specific title for the individual, maintaining semantic relationships comprising associating identities to roles in the virtual organization hierarchy based on words and phrases present in social media data of the individual; and,
the generating further comprising inferring roles and identities of individuals within the virtual organization hierarchy by identifying unused roles in the virtual organization hierarchy and combining a probability of assignment to those roles with the associating identities or roles.

12. The system of claim 7, wherein:
the virtual organization hierarchy represents a plurality of roles within the organization, a hierarchy of roles within the organization, relationships between roles within the organization, and a plurality of keys, values, and weight indicators related to the roles and relationships;
the generating further comprises assigning social media identities, email addresses, business card information, and factual indicators to the plurality of individuals within the virtual hierarchy
assigning respective metric values to the factual indicators, the metric values representing a veracity of respective factual indicators.

13. A non-transitory, computer-readable storage medium embodying computer program code, the computer program code comprising computer executable instructions configured for:
identifying a plurality of target individuals within an organization;
monitoring a plurality of social media data and interactions of the target individuals with the plurality of social media data; and,
generating the virtual organization hierarchy for the target individuals within the organization based upon influence of the plurality of individuals within the organization

14. The non-transitory, computer-readable storage medium of claim 13, wherein:
the virtual organizational hierarchy comprises information regarding at least some of individuals, roles, contact information, responsibilities, estimates of purchasing authority, and other influential values.

15. The non-transitory, computer-readable storage medium of claim 13, wherein:
the generating further comprises identifying a type of organization and accessing a templates for organizations corresponding to the type of organization.

16. The non-transitory, computer-readable storage medium of claim 13, wherein:
enhancing the virtual organization hierarchy as additional information becomes available from direct engagements and social media profiles.

17. The non-transitory, computer-readable storage medium of claim 13, wherein:
the generating comprises maintaining semantic relationships between roles and individuals, the semantic relationships enabling the virtual hierarchy to be used to identify missing decision makers and influencers in the organization, including an ability to infer a role of an individual within the hierarchy without knowing a specific title for the individual, maintaining semantic relationships comprising associating identities to roles in the virtual organization hierarchy based on words and phrases present in social media data of the individual; and,
the generating further comprising inferring roles and identities of individuals within the virtual organization hierarchy by identifying unused roles in the virtual organization hierarchy and combining a probability of assignment to those roles with the associating identities or roles.

18. The non-transitory, computer-readable storage medium of claim 13, wherein:
the virtual organization hierarchy represents a plurality of roles within the organization, a hierarchy of roles within the organization, relationships between roles within the organization, and a plurality of keys, values, and weight indicators related to the roles and relationships;
the generating further comprises assigning social media identities, email addresses, business card information, and factual indicators to the plurality of individuals within the virtual hierarchy; and,
assigning respective metric values to the factual indicators, the metric values representing a veracity of respective factual indicators.
